(19) United States
(12) Patent Application Publication
(10) Pub. No.: US 2013/0238888 A1
(43) Pub. Date: Sep. 12, 2013

(54) AUTOMATIC DEVICE RECONFIGURATION

(71) Applicant: Steven Daniel Rosas, Manlius, NY (US)

(72) Inventor: Steven Daniel Rosas, Manlius, NY (US)

(73) Assignee: BRIGHT HOUSE NETWORKS, LLC, East Syracuse, NY (US)

(21) Appl. No.: 13/415,179

(22) Filed: Mar. 8, 2012

(51) Int. Cl. G06F 15/177

(52) U.S. Cl. 713/100

(57) ABSTRACT

Automatic reconfiguration of a device is disclosed. A computing device makes a determination that a first remote control device (RCD) of multiple RCDs is selected for use by a user. The computing device accesses a configuration record of multiple configuration records. The configuration record corresponds to the first RCD. The computing device then reconfigures based on the configuration record.

### FIELD OF THE DISCLOSURE

The present disclosure relates to device reconfiguration, and in particular to automatic reconfiguration of a device based on a selected remote control.

### BACKGROUND

Many devices allow a user to configure aspects of the device to the user's personal tastes. These tastes can range from aesthetic to functional. A common example is a personal computer. Personal computers typically allow a user to configure many aspects of the user experience to the user's personal preferences, including, for example, the particular image displayed on the desktop, which gadgets automatically execute, folder options, fonts, and the like.

Computers are frequently used by a single user, and thus the time invested in configuring a computer is well spent, because once configured, the user will enjoy the personalization each time the user uses the computer. Other devices, however, are by their nature multi-user devices that over a period of time are used by multiple different users. A cable set-top box used by a family is an example of such a device. Few users will continually reconfigure a set-top box each time they want to watch television. Consequently, features, especially functional features, are frequently not utilized. For example, many set top boxes offer a programmable favorites channel list which, once programmed, allows the user to move sequentially across the channels added to the list. However, one family member's favorite channels are likely to be substantially different from another family member's favorite channels, and thus each user would need to reprogram the favorites channel list to their personal preferences each time they wished to watch television. This is burdensome, and consequently users frequently choose not to use such features.

Accordingly, it would be desirable if a device could automatically reconfigure itself to a particular configuration with minimal or no effort on the part of the user.

### SUMMARY

The present disclosure relates to automatic reconfiguration of a computing device based on a user selection of a remote control device. In one embodiment, the computing device makes a determination that a first remote control device of a plurality of remote control devices has been selected for use by a user. The computing device accesses a configuration record that corresponds to the first remote control device. The computing device then reconfigures itself based on the configuration record. In one embodiment, the computing device makes the determination that the first remote control device was selected based on a signal received from the first remote control device that identifies the first remote control device.

In one embodiment, the computing device may obtain the configuration record from a local storage of the computing device. In another embodiment, the computing device may obtain the configuration record from a remote storage via a network. In yet another embodiment, the computing device may obtain the configuration record from the first remote control device.

The computing device may register each remote control device of the plurality of remote control devices. For each remote control device that is registered, the computing device establishes a configuration record that corresponds to the remote control device. The configuration record may include configuration data that includes a user theme identifier, a user favorites list, a user content purchase flag, and/or user content ratings restrictions, for example. Reconfiguring the computing device may include configuring a current theme based on the user theme identifier, configuring a current favorites list based on the user favorites list, configuring a current content purchase flag based on the user content purchase flag, and/or configuring current content ratings restrictions based on the user content ratings restrictions.

The computing device may, in one embodiment, authenticate the user of the first remote control device after making the determination that the first remote control device was selected. For example, the computing device may request an identifier from the user, and after receiving the identifier, determine that the identifier is associated with the user.

In one embodiment, the computing device communicates to a remote server an indication that the first remote control device has been selected for use by a user. The computing device may also communicate to the remote server content selections received from the first remote control device. Such content selections may comprise, for example, information identifying recorded programs, selected channels, channel changes, amount of time spent on a particular channel, and the like. The computing device may receive from the remote server tailored content, and/or tailored recommendations, based on the indication of the first remote control device. The computing device may then effect presentation of the content, or recommendations, to the user.

The computing device may comprise, for example, a set-top box, a digital video recorder, a television, or a game console. The remote control device may comprise a universal remote control device, a smartphone, or a computing tablet, for example.

Those skilled in the art will appreciate the scope of the present disclosure and realize additional aspects thereof after reading the following detailed description of the preferred embodiments in association with the accompanying drawing figures.

### BRIEF DESCRIPTION OF THE DRAWING FIGURES

The accompanying drawing figures incorporated in and forming a part of this specification illustrate several aspects of the disclosure, and together with the description serve to explain the principles of the disclosure.

FIG. 1 is a block diagram of an exemplary computing device according to one embodiment;

FIG. 2 is a flowchart of an exemplary process for automatically reconfiguring the computing device according to one embodiment;

FIG. 3 is a block diagram of an exemplary system in which another embodiment of the present disclosure may be practiced;

FIG. 4 is flowchart of an exemplary process for providing content to the computing device based on the selected remote control device;

FIG. 5 is a block diagram of a system in which another embodiment may be practiced; and

FIG. 6 is a more detailed block diagram of the exemplary computing devices illustrated in FIGS. 1, 3, and 5.

### DETAILED DESCRIPTION

The embodiments set forth below represent the necessary information to enable those skilled in the art to practice the embodiments and illustrate the best mode of practicing the embodiments. Upon reading the following description in light of the accompanying drawing figures, those skilled in the art will understand the concepts of the disclosure and will recognize applications of these concepts not particularly addressed herein. It should be understood that these concepts and applications fall within the scope of the disclosure and the accompanying claims.

The present disclosure relates to automatic reconfiguration of a device, such as a computing device, based on a user selection of a remote control device. Thus, the computing device may continually reconfigure itself over time, as different users select different remote control devices. In this manner, each user is automatically presented with his or her preferred configuration simply by selecting a particular remote control device.

In one embodiment, the computing device makes a determination that a first remote control device of a plurality of remote control devices has been selected for use by a user. The computing device accesses a configuration record that corresponds to the first remote control device. The computing device then reconfigures itself based on the configuration record.

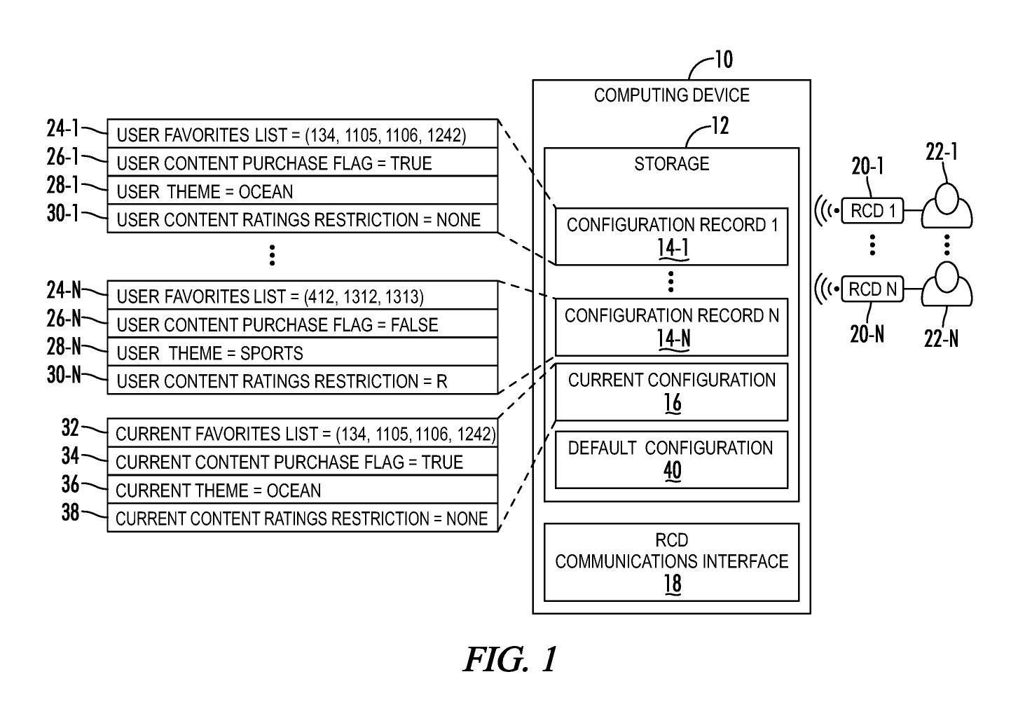

FIG. 1 is a block diagram of an exemplary computing device 10 according to one embodiment. The computing device 10 may comprise any device comprising a processor and capable of implementing the functionality described herein, such as a computer, a stereo receiver, a media station, and the like. For purposes of illustration, embodiments will be described herein in the context of a cable operating system, and the computing device 10 comprises a media station such as a set-top box; a digital video recorder; or another media console, such as a Microsoft® Xbox® or Sony PlayStation®, but the present disclosure is not limited to such devices.

The computing device 10 includes a storage 12 in which multiple configuration records 14-1-14-N (generally, configuration records 14) are stored. The storage 12 may comprise any suitable component or mechanism for storing data in a non-volatile manner, such as a hard disk drive or solid state hard drive. Each configuration record 14 contains one or more configuration parameters that may be used by the computing device 10 to configure features of the computing device 10. In particular, the configuration parameters from a configuration record 14 may be used to modify a current configuration 16 of the device. Although the term “record” is used for purposes of illustration, any suitable structure may be used for storing the configuration parameters.

The computing device 10 also includes a remote control device (RCD) communications interface 18, which is capable of communicating, or at least receiving communications from, one or more RCDs 20-1-20-N (generally, RCDs 20). The RCD communications interface 18 may comprise any suitable technology that corresponds to a communications technology used by the RCDs 20, such as infrared, Bluetooth®, ZigBee®, Wi-Fi, or the like. The RCDs 20 may comprise any suitable devices capable of sending commands via signals to the computing device 10, such as a universal or proprietary RCD, a smartphone, a computer tablet, a laptop computer, or the like. As will be discussed in greater detail herein, in one embodiment each RCD 20 comprises an accelerometer, or another component or components capable of detecting a movement of the RCD 20.

Each RCD 20 preferably, but not necessarily, corresponds to a different user 22-1-22-N (generally, users 22). Each RCD 20 also corresponds to a particular configuration record 14. For example, the RCD 20-1 corresponds to the configuration record 14-1, and the RCD 20-N corresponds to the configuration record 14-N. For purposes of illustration only, the RCD 20-1 may be referred to herein as the “first RCD 20-1” and the RCD 20-N may be referred to herein as the “second RCD 20-N.” The use of ordinals herein in conjunction with an element is solely for distinguishing what might otherwise be similar or identical labels, such as “first RCD” and “second RCD,” and does not imply a priority, an importance, or anything else, unless otherwise stated herein.

A user 22 accesses the computing device 10 to configure the configuration parameters maintained in the corresponding configuration record 14 with desired values. In one embodiment, the user 22 selects a particular RCD 20 to configure the configuration record 14, or to initially generate the configuration record 14, that corresponds to the particular RCD 20. For example, in a one-time setup phase, the user 22-1 may select the first RCD 20-1 to access a configuration menu provided by the computing device 10, and may register the first RCD 20-1 with the computing device 10. The registration may include an identifier that identifies the first RCD 20-1 to the computing device 10, and which may later be used by the first RCD 20-1 to signal the computing device 10 that the first RCD 20-1 has been selected for use. The computing device 10 may then generate the configuration record 14-1, initially with no, or empty, values for the various configuration parameters stored in the configuration record 14-1. The user 22-1 may then select, indicate, or otherwise provide values for the configuration parameters that are stored in the configuration record 14-1. The configuration mechanism may require a particular authorization to limit modification of the configuration record 14-1 to one more authorized individuals, such as parents, or may limit modification of only certain configuration parameters to such an authorized individual and permit any user 22 of the first RCD 20-1 to configure other parameters.

Configuration parameters may comprise any number of configurable features of the computing device 10. For example, one configuration parameter may comprise a user favorites list 24-1 (generally, user favorites lists 24) that identifies favorites, such as favorite channels, of the user 22-1. In this example, the values of the user favorites list 24-1 are 134, 1105, 1106, and 1242, which identifies those channels as the favorite channels associated with the first RCD 20-1. Another configuration parameter may comprise a user content purchase flag 26-1 (generally, content purchase flags 26) that indicates whether or not the user 22-1 of the first RCD 20-1 is permitted to order, or otherwise purchase, content, such as video-on-demand (VOD) programs, or the like. In this example, the value of the user content purchase flag 26-1 is TRUE, indicating that the user 22-1 of the first RCD 20-1 is permitted to order content. A user theme 28-1 (generally, user themes 28) configuration parameter identifies a particular theme for use by the computing device 10. A theme may comprise a certain type of electronic programming guide (EPG), or visual characteristics associated therewith; certain background colors used to provide information, such as the EPG or caller ID information; or any other attributes or attributes that are presented to a user 22 when interacting with the computing device 10. Typically, a computing device 10 may offer a plurality of preconfigured themes for use by a user 22, so the user 22 need only select a particular theme. In this example, the value of the user theme 28-1 is identified as OCEAN.

A user content ratings restriction 30-1 (generally, user content ratings restriction 30) configuration parameter identifies program ratings of programs that may be prevented from being displayed by the computing device 10. In this example, the value of the user content ratings restriction 30-1 is identified as NONE, indicating that there are no restrictions on the programs that may be viewed by the user 22-1 of the first RCD 20-1. In a similar manner, the configuration record 14-N, which corresponds to the second RCD 20-N, may be configured with configuration values by a user 22-N. The configuration record 14-N may have identical configuration parameters to those discussed with regard to the configuration record 14-1, including a user favorites list 24-N, a user content purchase flag 26-N, a user theme 28-N, and a user content ratings restriction 30-N. Each of such configuration parameters, however, may have the same or different values as those in the configuration record 14-1. For example, the value of the user content ratings restriction 30-N configuration parameter is R, indicating that the computing device 10 will prevent presentation of any programs having a program rating of R when the current configuration of the computing device 10 is based on the configuration record 14-N.

Configuration parameters are not limited to those discussed specifically herein, and may comprise any feature or content that may be configurable given the particular computing device 10. For example, configuration parameters may identify preferred applications which may be displayed to a user 22, and/or how such applications are configured when selected by the user 22. For example, if the computing device 10 is capable of executing OpenCable Application Platform (OCAP) applications, then configuration parameters may identify preferred OCAP applications that will be displayed to the user 22 based on the selected RCD 20, and could also set configuration options of the preferred OCAP applications based on the selected RCD 20.

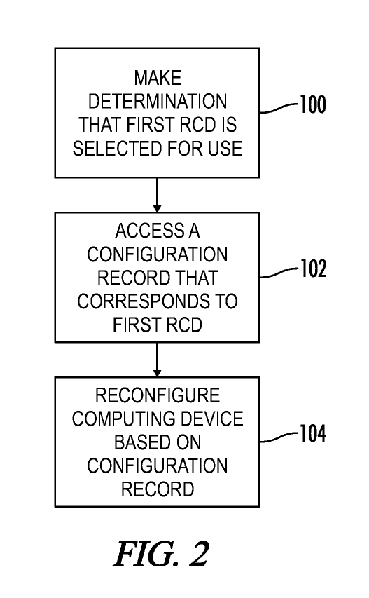

In one embodiment, based upon which RCD 20 is selected for use, the computing device 10 automatically reconfigures itself based on the configuration record 14 that corresponds to the RCD 20 which was selected for use. FIG. 2 is a flowchart of an exemplary process for automatically reconfiguring the computing device 10, and will be discussed in conjunction with FIG. 1. Initially, the computing device 10 makes a determination that a particular RCD 20 has been selected for use (FIG. 2, block 100). The determination may be based upon a signal received from the particular RCD 20. For example, assume that the user 22-1 picks up the first RCD 20-1 with an expectation to interact with the computing device 10 via the first RCD 20-1. The first RCD 20-1 may contain an accelerometer, or other component, that detects the movement of the first RCD 20-1, and upon detection thereof, may communicate a signal to the computing device 10 that identifies the first RCD 20-1. For example, the signal may comprise a packet of data that indicates that the first RCD 20-1 has been selected for use by the user 22-1.

In another embodiment, the user 22-1 may first need to activate a hard or soft button on the first RCD 20-1 before the first RCD 20-1 communicates the signal to the computing device 10. For example, the first RCD 20-1 may offer a Start button which, when selected, communicates the signal to the computing device 10 that the first RCD 20-1 has been selected for use.

Optionally, upon receipt of the signal from the first RCD 20-1, the computing device 10 may authenticate the user 22-1. In this embodiment, not only is there a correspondence between a particular RCD 20 and a particular configuration record 14, but there is also a correspondence between the user 22-1, the first RCD 20-1, and the configuration record 14-1, such that only the user 22-1 should be provided access to the configuration parameters associated with the configuration record 14-1. For example, a parent may want to prevent a child from initiating an automatic reconfiguration of the computing device 10 in accordance with a configuration record 14 that is configured for an adult. Accordingly, upon receipt of the signal from the first RCD 20-1, the computing device 10 may present the user 22-1 with a question, the answer to which is stored in the storage 12, or request from the user 22-1 a password, and authenticate the response from the user 22-1.

In yet another embodiment, the first RCD 20-1 may authenticate the user 22-1 prior to sending the signal to the computing device 10. The first RCD 20-1 may, in a process similar to that discussed above, request information from the user 22-1 and compare the provided information, such as a password or response to a question, to information stored in the first RCD 20-1. Alternatively, the first RCD 20-1 may comprise a camera and image or facial recognition technology and authenticate the user 22-1 based on a concurrently captured image of the user 22-1. The first RCD 20-1 may use other suitable mechanisms as well, such as fingerprint technology, retina scanning technology, or other biometric validation techniques. If the first RCD 20-1 is not able to authenticate the user 22-1, the first RCD 20-1 refrains from sending the signal to the computing device 10.

The computing device 10 may also optionally first confirm that automatic reconfiguration of the computing device 10 is desired. For example, it may be the case that an action that results in the first RCD 20-1 communicating the signal to the computing device 10 was not intended to cause an automatic reconfiguration of the computing device 10. Accordingly, the computing device 10 may first confirm that the automatic reconfiguration is desired. Such confirmation may take any suitable form, such as effecting display of a “Confirm Personalization Change?” message on a display device, such as television, which requires a Yes or No response from the user 22-1 via an RCD 20.

Assuming that either no authentication was undertaken, or that the user 22-1 was properly authenticated, and that either no confirmation was requested, or that a confirmation was received, the computing device 10 accesses the configuration record 14-1 that corresponds to the first RCD 20-1 (FIG. 2, block 102). The computing device 10 then reconfigures the computing device 10 based on the configuration record 14-1 (FIG. 2, block 104). In particular, the computing device 10 accesses the values of the configuration parameters stored in the configuration record 14-1 and loads them into the current configuration 16 of the computing device 10. For example, based on the configuration record 14-1, a current favorites list 32 is set to the value of 134, 1105, 1106, and 1242, the same value as the user favorites list 24-1. A current content purchase flag 34 is set to TRUE, the same value as the user content purchase flag 26-1. A current theme 36 is set to OCEAN, the same value as the user theme 28-1. A current content ratings restriction 38 is set to NONE, the same value as the user content ratings restriction 30-1. Thereafter, the computing device 10 operates in accordance with the current configuration 16. For example, if the user 22-1 selects a “favorites” button on the first RCD 20-1, the computing device 10 allows the user 22-1 to easily select channels 134, 1105, 1106, and 1242. As another example, the computing device 10 will permit the user 22-1 to order content, such as VOD programming, for example, based on the value of the current content purchase flag 34.

In one embodiment, the computing device 10 may, after a predetermined period of inactivity, or after a predetermined event, such as the end of a program, re-authenticate the user 22-1 to ensure the user 22-1 is still physically present. If the user 22-1 cannot be re-authenticated, or after certain events have occurred, such as the power-up of the computing device 10, the computing device 10 may reconfigure itself in accordance with a default configuration 40. The default configuration 40 may also be configured by an authorized user 22, in the manner described above with regard to the configuration record 14-1.

Assume that subsequent to the automatic reconfiguration of the computing device 10 based on the configuration record 14-1, the user 22-N selects the second RCD 20-N for use. The computing device 10 makes the determination that the second RCD 20-N has been selected for use, accesses the configuration record 14-N that corresponds to the second RCD 20-N, and reconfigures the computing device 10 based on the configuration record 14-N. In this manner, configuration of the computing device 10 is coupled to the RCD 20 that is selected for use.

In one embodiment, a service provider, such as a multiple system operator (MSO), may rent, lease, or sell multiple RCDs 20 to a family. Each RCD 20 may have different aesthetic characteristics to easily distinguish the RCDs 20, such as different faceplates, or the like. A user 22, such as a parent, may designate that each RCD 20 corresponds to a particular family member, and then establish a configuration record 14 in the manner discussed above for each RCD 20, providing configuration parameter values suitable for the corresponding family member. This embodiment provides a relatively easy mechanism for not only enabling each user 22 to interface with the computing device 10 in a personalized manner, but also implementing control over which programming any particular user 22 may access.

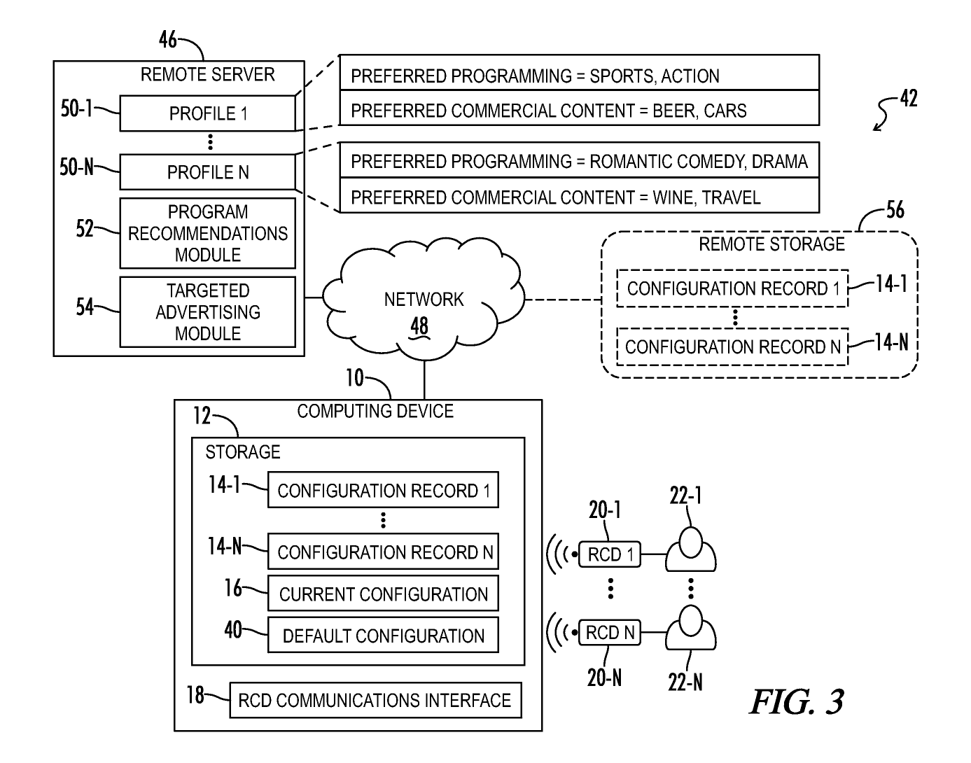

FIG. 3 is a block diagram of an exemplary system 42 in which another embodiment of the present disclosure may be practiced. The system 42 comprises the computing device 10 and a remote server 46, each of which is communicatively coupled to a network 48. The remote server 46 may comprise, for example, a head end or other computing device or computing devices that provide functionality to one or more computing devices 10 via the network 48. The network 48 may comprise any public or proprietary network, or combination thereof, that permits communication between the remote server 46 and the computing device 10.

In this embodiment, the computing device 10 provides viewer information to the remote server 46 that corresponds to a particular RCD 20. Such viewer information may comprise, for example, information identifying recorded programs; viewed programs or channels; preferred or favorite metadata, such as actors, genres, music, or the like; channel changes; amount of time spent on a particular channel or program; or the like. In particular, the computing device 10 identifies a particular action of an RCD 20 along with the identification of the particular RCD 20. The remote server 46 uses such information to generate and/or maintain profiles 50-1-50-N (generally, profiles 50), each of which corresponds to a particular RCD 20. In particular, in this example, the profile 50-1 corresponds to the first RCD 20-1 and the profile 50-N corresponds to the second RCD 20-N. The profiles 50 contain preference information that identifies preferences associated with the corresponding RCD 20 based on the viewer information received from the computing device 10.

For example, based on the viewer information that corresponds to the first RCD 20-1, the profile 50-1 may identify preferred programming as sports programs and action programs. The profile 50-1 may identify preferred commercial content as beer commercials and car commercials. Based on the viewer information that corresponds to the second RCD 20-N, the profile 50-N may identify preferred programming as romantic comedy programs and drama programs. The profile 50-N may identify preferred commercial content as wine commercials and travel commercials.

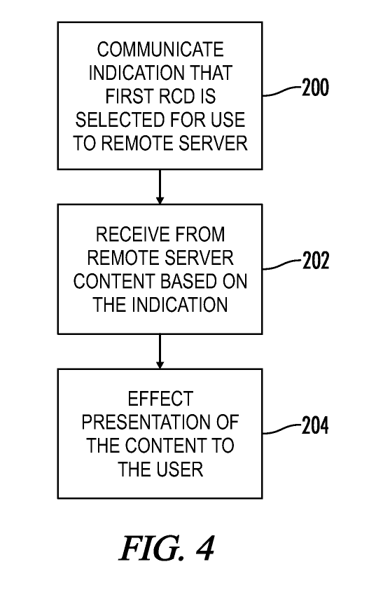

The remote server 46 may use a profile 50 to provide certain content, or cause certain content to be provided, to the computing device 10 based on the currently selected RCD 20. FIG. 4 is flowchart of an exemplary method for providing content to the computing device 10 based on the selected RCD 20, and will be discussed in conjunction with FIG. 3. Assume for purposes of illustration that the user 22-1 selects the first RCD 20-1 for use. The computing device 10 makes the determination that the first RCD 20-1 has been selected for use, in the manner discussed above with regard to FIG. 2, for example. The computing device 10 then communicates an indication to the remote server 46 that the first RCD 20-1 has been selected for use (FIG. 4, block 200). The remote server 46 accesses the profile 50-1, which corresponds to the first RCD 20-1, and effects communication of certain content to the computing device 10 based on the profile 50-1. For example, the remote server 46 may include a program recommendations module 52 that accesses an EPG (not illustrated), and based on the preferred programming identified in the profile 50-1, provides recommendations on current or imminent programming to the computing device 10. The remote server 46 may also include a targeted advertising module 54 that selects a particular advertisement based on the preferred commercial content identified in the profile 50-1, and causes such particular advertisement to be communicated to the computing device 10.

The computing device 10 receives the content from the remote server 46 (FIG. 4, block 202). The computing device 10 then effects presentation of the content to the user 22-1 via a display device (FIG. 4, block 204). For example, the computing device 10 may present the content via a television (not illustrated).

The system 42 may also include a remote storage 56 for storing the configuration records 14. In this embodiment, the computing device 10 may store the configuration records 14 remotely in the remote storage 56 rather than, or in addition to, storing them locally in the storage 12. One advantage to storing the configuration records 14 remotely is that such configuration records 14 may be more easily accessed by more than one computing device 10. For example, if a household has multiple computing devices 10, each computing device 10 may automatically reconfigure itself based on a selected RCD 20, without having to manually configure each computing device 10 for each RCD 20. Thus, each computing device 10 may access the remote storage 56 to select the appropriate configuration record 14 upon determining that a particular RCD 20 has been selected for use. Alternately, changes to the configuration records 14 in the remote storage 56 may be propagated to the local storage 12, such that the configuration records 14 are stored in both the remote storage 56 and the local storage 12, and are synchronized as they are changed. Another advantage to the use of a remote storage 56 is that if the computing device 10 is replaced or upgraded, for example, the configuration records 14 may be easily reapplied to the new computing device 10, without the need to re-enter the information contained in the configuration records 14.

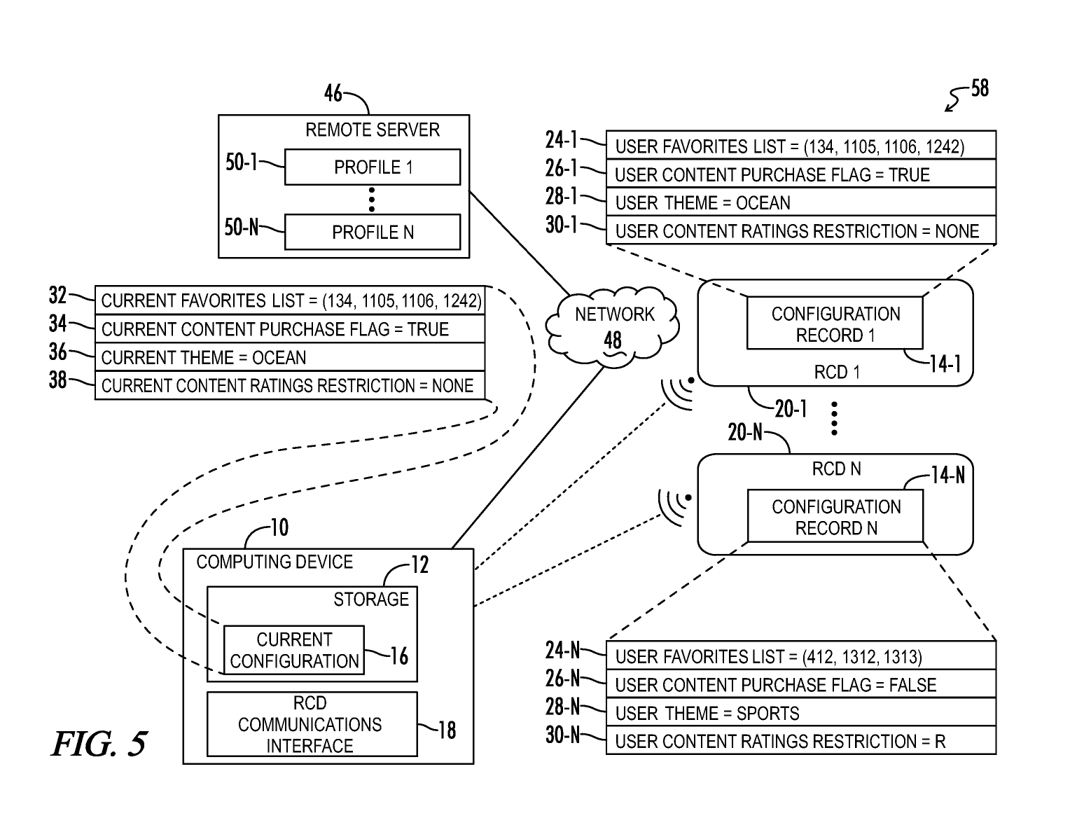

FIG. 5 is block diagram of a system 58 in which an additional embodiment of the present disclosure may be practiced. In this embodiment, the computing device 10 receives the configuration records 14 from the corresponding RCD 20 rather than the storage 12. Assume, for purposes of illustration, that the user 22-1 selects the first RCD 20-1 for use. The first RCD 20-1 may signal the computing device 10 that the first RCD 20-1 has been selected for use, and may also substantially concurrently therewith communicate the configuration record 14-1 to the computing device 10. The computing device 10 receives the configuration record 14-1, accesses the values of the configuration parameters stored in the configuration record 14-1, and loads the configuration parameters into the current configuration 16 of the computing device 10.

In this embodiment, the first RCD 20-1 may include a configuration module that enables the user 22-1 to identify, via the first RCD 20-1, the values that correspond to the configuration parameters in the configuration record 14-1. Alternatively, the first RCD 20-1 may be coupled to another computing device, such as a personal computer, which provides an interface via which the configuration record 14-1 may be generated and stored in the first RCD 20-1. This embodiment provides another mechanism for facilitating automatic reconfiguration of any computing device 10 of multiple computing devices 10 in a desired manner. For example, as discussed above with regard to FIG. 3, if a household has multiple computing devices 10, a user 22 need only program a particular RCD 20 once, and the configuration will then apply to any computing device 10 in the household.

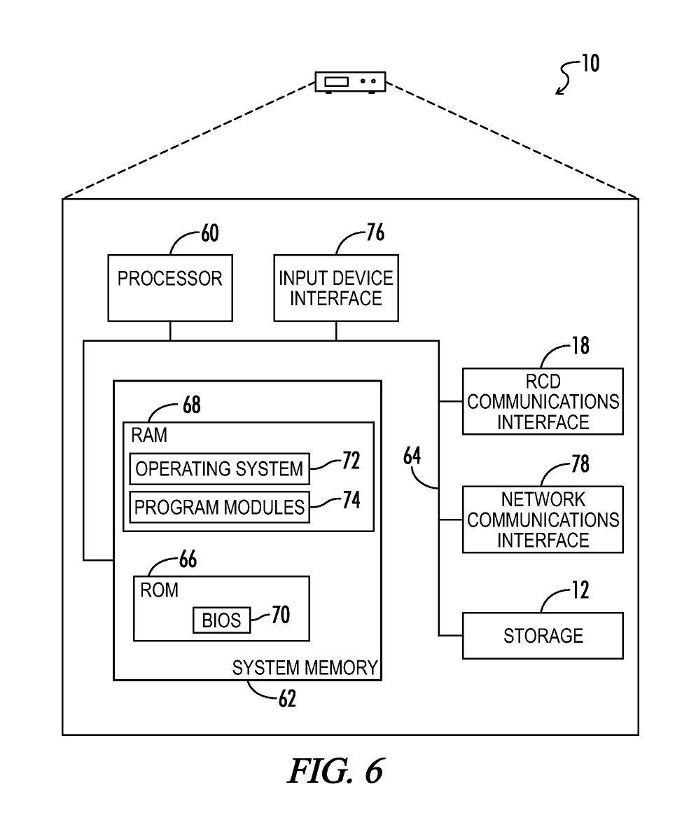

FIG. 6 illustrates an exemplary computing device 10 according to one embodiment. As discussed above, the computing device 10 may comprise any device comprising a processor and capable of implementing the functionality described herein, such as a computer, a stereo receiver, a set-top box, a digital video recorder, a television, or another media console such as a Microsoft® Xbox® or Sony PlayStation®. The computing device 10 comprises a processor 60 that is coupled to a system memory 62 via a system bus 64. The system bus 64 provides an interface for system components including, but not limited to, the system memory 62 and the processor 60. The processor 60 can be any of various commercially available or proprietary processors. Dual microprocessors and other multi-processor architectures may also be employed as the processor 60.

The system bus 64 may be any of several types of bus structures that may further interconnect to a memory bus (with or without a memory controller), a peripheral bus, and/or a local bus using any of a variety of commercially available bus architectures. The system memory 62 may include non-volatile memory 66 (e.g., read only memory (ROM), erasable programmable read only memory (EPROM), electrically erasable programmable read only memory (EEPROM), etc.) and/or volatile memory 68 (e.g., random access memory (RAM)). A basic input/output system (BIOS) 70 may be stored in the non-volatile memory 66, and can include the basic routines that help to transfer information between elements within the computing device 10. The volatile memory 68 may also include a high-speed RAM, such as static RAM, for caching data.

The computing device 10 may further include the storage 12, which may comprise, for example, an internal hard disk drive (HDD) (e.g., enhanced integrated drive electronics (EIDE) or serial advanced technology attachment (SATA)) for storage, flash memory, or the like. The storage 12 and associated computer-readable and computer-usable media provide non-volatile storage of data and data structures such as the configuration records 14, current configuration 16, and default configuration 40, as well as computer-executable instructions, and so forth. Although the description of computer-readable media above refers to an HDD, it should be appreciated by those skilled in the art that other types of media which are readable by a computer, such as Zip disks, magnetic cassettes, flash memory cards, cartridges, and the like, may also be used in the exemplary operating environment, and further, that any such media may contain computer-executable instructions for performing the novel functionality described herein.

A number of program modules can be stored in the storage 12 and in the volatile memory 68, including an operating system 72 and one or more program modules 74, which may implement the functionality described herein in whole or in part. It is to be appreciated that the embodiments can be implemented with various commercially available operating systems 72 or combinations of operating systems 72.

All or a portion of the embodiments may be implemented as a computer program product, such as a non-transitory computer-usable or computer-readable medium having a computer-readable program code embodied therein. The computer-readable program code can include complex software instructions for implementing the functionality of the embodiments described herein when executed on the processor 60. The processor 60, in conjunction with the program modules 74 in the volatile memory 68, may serve as a controller, or as a control system, for the computing device 10 that is configured to, or adapted to, implement the functionality described herein.

An administrator may be able to enter commands and information into the computing device 10 through one or more input devices, such as, for example, a touch-sensitive display (not illustrated); a keyboard (not illustrated); a pointing device, such as a mouse (not illustrated); or, of course, an RCD 20. Other input devices (not illustrated) may include a microphone, an infrared (IR) remote control, a joystick, a game pad, a stylus pen, or the like. These and other input devices are often connected to the processor 60 through an input device interface 76 that is coupled to the system bus 64, but can be connected by other interfaces such as a parallel port, an IEEE 1394 serial port, a game port, a universal serial bus (USB) port, an IR interface, etc.

The computing device 10 also includes the RCD communications interface 18 that is configured to communicate with the RCDs 20. The RCD communications interface 18 may comprise, for example, a ZigBee interface, a BlueTooth interface, a WiFi interface, or any other suitable wireless or wired interface. The computing device preferably includes a network communications interface 78 that is configured to communicate with a network, such as the network 48.

While embodiments herein have been disclosed in the context of a cable operating system, it will be appreciated that the principles are applicable to a wide variety of computing devices, in multiple different contexts. Generally, the principles apply to any computing device wherein it is desired to automatically reconfigure the computing device based on a selected remote control device.

Those skilled in the art will recognize improvements and modifications to the preferred embodiments of the present disclosure. All such improvements and modifications are considered within the scope of the concepts disclosed herein and the claims that follow.

What is claimed is:

1. A method for automatically reconfiguring a device comprising:
making, by the device, a determination that a first remote control device (RCD) of a plurality of RCDs is selected for use;
accessing, by the device, a first configuration record of a plurality of configuration records, the first configuration record corresponding to the first RCD; and
reconfiguring the device based on the first configuration record.

2. The method of claim 1 wherein making the determination that the first RCD of the plurality of RCDs is selected for use comprises receiving a signal from the first RCD identifying the first RCD.

3. The method of claim 2 further comprising authenticating a user of the first RCD.

4. The method of claim 3 wherein authenticating the user of the first RCD comprises requesting an identifier from the user, receiving the identifier, and determining that the identifier is associated with the user.

5. The method of claim 1 wherein accessing the first configuration record of the plurality of configuration records comprises obtaining the first configuration record from a local storage of the device.

6. The method of claim 1 wherein accessing the first configuration record of the plurality of configuration records comprises obtaining the first configuration record from a remote storage via a network.

7. The method of claim 1 wherein accessing the first configuration record of the plurality of configuration records comprises obtaining the first configuration record from the first RCD.

8. The method of claim 1 further comprising:
registering each RCD of the plurality of RCDs; and
for each RCD, establishing a configuration record of the plurality of configuration records that corresponds to the each RCD.

9. The method of claim 1 wherein reconfiguring the device based on the first configuration record comprises at least one of configuring a current favorites list based on the first configuration record, establishing a current theme based on the first configuration record, and inhibiting access to certain content based on the first configuration record.

10. The method of claim 1 further comprising:
communicating an indication that the first RCD is selected for use to a remote server; and
communicating content selections received from the first RCD to the remote server.

11. The method of claim 1 further comprising:
communicating an indication that the first RCD is selected for use to a remote server;
in response to communicating the indication to the remote server, receiving content based on the indication; and
effecting presentation of the content to a user.

12. The method of claim 1 wherein the device comprises one of a set top box, a digital video recorder, a television, and a game console.

13. The method of claim 1 wherein the first RCD comprises one of a universal RCD, a smartphone, and a computing tablet.

14. The method of claim 1 further comprising:
requesting, by the device, confirmation that an automatic reconfiguration of the device is desired; and
receiving, by the device, user input confirming that the automatic reconfiguration is desired.

15. The method of claim 1, further comprising:
making a determination that a second RCD of the plurality of RCDs is selected for use;
accessing a second configuration record of the plurality of configuration records, the second configuration record corresponding to the second RCD; and
reconfiguring the device based on the second configuration record.

16. A computing device comprising:
a remote control device (RCD) interface configured to communicate with a plurality of RCDs;
a processor coupled to the RCD interface and configured to:
make a determination that a first RCD of the plurality of RCDs is selected for use;
access a configuration record of a plurality of configuration records, the configuration record corresponding to the first RCD; and
reconfigure the computing device based on the configuration record.

17. The computing device of claim 16, wherein to make the determination that the first RCD of the plurality of RCDs is selected for use, the processor is further configured to receive a signal from the first RCD identifying the first RCD.

18. The computing device of claim 16 wherein the processor is further configured to authenticate a user of the first RCD.

19. The computing device of claim 16, wherein the processor is further configured to:
communicate an indication that the first RCD is selected for use to a remote server;
in response to communicating the indication to the remote server, receive content based on the indication; and
effect presentation of the content to a user.

20. A computer program product for automatically reconfiguring a device, the computer program product stored on a non-transitory computer-readable storage medium and including instructions configured to cause a processor to carry out the steps of:
making, by the device, a determination that a first remote control device (RCD) of a plurality of RCDs is selected for use;
accessing, by the device, a configuration record of a plurality of configuration records, the configuration record corresponding to the first RCD; and
reconfiguring the device based on the configuration record.

21. The computer program product of claim 20, wherein making the determination that the first RCD of the plurality of RCDs is selected for use further comprises receiving a signal from the first RCD identifying the first RCD.

22. The computer program product of claim 20, wherein the instructions are further configured to cause the processor to carry out the steps of:
communicating an indication that the first RCD is selected for use to a remote server;
in response to communicating the indication to the remote server, receiving content based on the indication; and
effecting presentation of the content to a user.
